(19) United States
(12) Patent Application Publication
(10) Pub. No.: US 2022/0370836 A1
(43) Pub. Date: Nov. 24, 2022

(54) CLEAR-FACED, VIRUS PROTECTION FACE MASK FOR IMPROVED FACIAL RECOGNITION

(71) Applicants: Chance S. Johnson, Chicago, IL (US); Kevin Bartels, Frisco, TX (US); Andrea Williams, Chicago, IL (US)

(72) Inventors: Chance S. Johnson, Chicago, IL (US); Kevin Bartels, Frisco, TX (US); Andrea Williams, Chicago, IL (US)

(21) Appl. No.: 17/325,679

(22) Filed: May 20, 2021

(51) Int. Cl. A62B 23/02; A62B 18/08; A41D 13/11

(52) U.S. Cl. CPC A62B 23/02; A62B 18/084; A41D 13/1138; G06K 9/00288

(57) ABSTRACT

A face shield of a face mask has two or more openings for attachment of air filters (e.g., COVID-19, T70 or T90 air filters). The two or more openings face towards the ground being substantially perpendicular to the nose and the lip of the face. A nose bridge attaches to a support fame and having a span from a first side of the nose over a top and to a second side of the nose. The nose bridge and connected portions of the support frame fully expose a front facing portion of the nose of the face.

### FIELD OF THE INVENTION

The invention relates generally to a wearable good, and more specifically, to a clear-faced, virus protection face mask for improved facial recognition.

### BACKGROUND

Face masks are likely to become the norm in the age of pandemics. One problem, however, is that the vast majority of face masks manufactured for virus protection preclude facial recognition capabilities for external security mechanisms. For example, air filters are placed directly in front of critical facial features relied upon for facial recognition. In another example, nose bridges that support a frame of face masks, and the frame as well, can obstruct specific points of a human face that are necessary to verify identity.

There are indeed some masks that are commercially labeled as “clear”. The face shield itself is clear by nature. Clarity with respect to technical operations of facial recognition technology, is distinct from clarity or transparency levels of parts alone. Furthermore, the nose bridge and the frame of commercially “clear” masks still tend to be composed of obstructive material, with respect to technical operations of facial recognition technology. Problematically, when performing a repetitive activity like checking a smart phone with facial recognition, the conventional face masks have to be temporarily removed to expose enough of a person's face for the recognition technology to properly secure assets.

Therefore, what is needed is a clear-faced virus protection face mask that exposes critical areas of a face needed for facial recognition.

### SUMMARY

These shortcomings are addressed by the present disclosure of goods and related computer software, for a clear-faced virus protection face mask that exposes critical areas of a face needed for facial recognition.

In one embodiment, a face mask includes a face shield with a support frame, the face shield being composed of a clear material to allow facial recognition. The face shield spans from at least a top of a nose of a face of a person wearing the face mask to a bottom of a lower lip of the face and fully exposes a front facing elevation of eyes, nose and lips of the face.

In another embodiment, the face shield has two or more openings for attachment of air filters (e.g., COVID-19, T70 or T90 air filters), the two or more openings substantially facing towards the ground being substantially perpendicular to the nose and the lip of the face. A nose bridge attached to the support fame and having a span from a first side of the nose over a top and to a second side of the nose, wherein the nose bridge and connected portions of the support frame fully expose a front facing portion of the nose of the face.

A face cushion attached to the support frame to seal the face mask. A strap pressurizes the support frame. In an embodiment, the strap is reversibly mounted to wrap around either a top portion of a head or a top portion of a neck.

Advantageously, user experience with face masks providing sufficient virus protection is improved.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a perspective diagram illustrating a clear-faced virus protection face mask that exposes critical areas of a face needed for facial recognition, according to one preferred embodiment.

FIG. 2 is a perspective diagram illustrating the clear-faced virus protection face mask on a subject and alone, according to an embodiment.

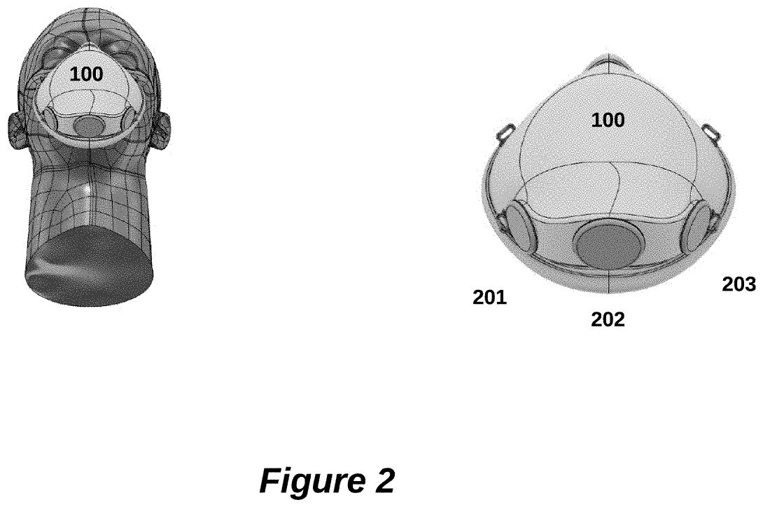

FIG. 3 are top, front, bottom and side views illustrating the clear-faced virus protection mask, according to a preferred embodiment.

FIG. 4 is an exploded view of the clear-faced virus protection mask, according to an embodiment.

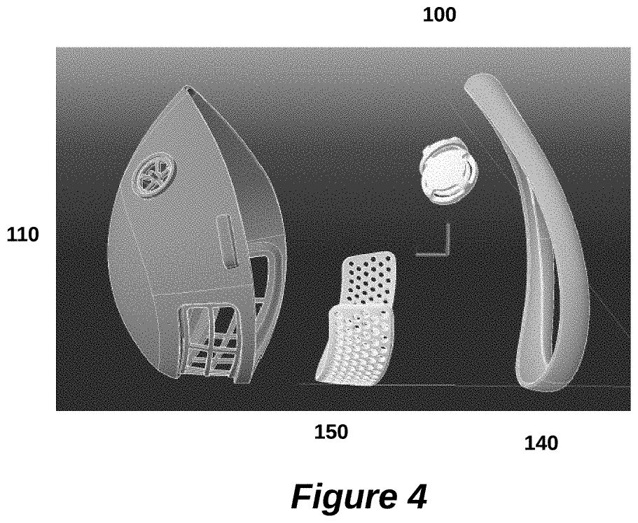

FIG. 5 is a side view of straps for the clear-faced virus protection mask, according to an embodiment.

FIG. 6 are perspective views of an eye goggle attachment to the clear-faced virus protection mask, according to an embodiment.

FIG. 7 is a high-level block diagram illustrating a system 700 for computerized facial recognition using the face mask 100, according to one embodiment.

### DETAILED DESCRIPTION

The description below provides goods and related facial recognition software and systems for a clear-faced virus protection face mask that exposes critical areas of a face needed for facial recognition. Facial recognition is enabled by an increased number of data points made available. A face mask shape, along with components arranged for minimum exposure profiles, users can conveniently move through security processes without the hassle or the health hazard created by taking off a face mask.

One of ordinary skill in the art will recognize many additional variations made possible by the succinct description of techniques below.

I. Face Mask for Facial Recognition

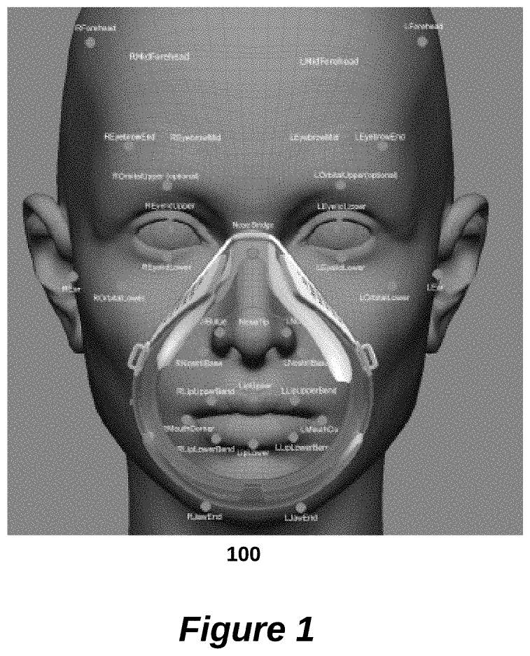

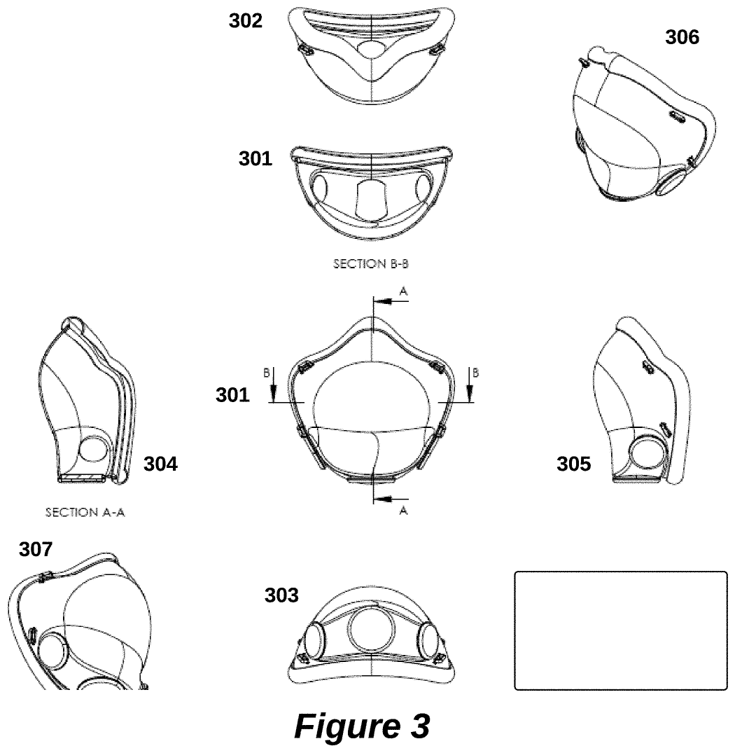

FIG. 1 is a perspective diagram illustrating a clear-faced, virus protection face mask 100 that exposes critical areas of a face needed for facial recognition, according to one embodiment. Several more views are shown in FIG. 3, including a front view 301, top views 301,302, bottom view 303, side views 304,305, and perspective views 306,307. The face mask 100 can be used in a variety of different environments, including airplanes, medical facilities, offices, outdoors, during exercise, just to give a few non-limiting examples. As a result, many other design variations of the face mask 100 with clear face are possible and are considered within the scope of the present disclosure.

The face mask 100 includes a face shield 110 with a support frame 120. The face shield 110 is preferably composed of a thin film of a clear material (e.g., plastic) to allow facial recognition. Some light tint or coloring may be tolerable, within a threshold that does not interfere with facial recognition systems. An anti-fog coating (e.g., 5-15 micrometers) can be applied to keep the transparency high. Importantly, critical areas of the face remain visible through the face mask 100, such as the eyes, the nose, the mouth and the chin.

The face shield 110 spans from at least a top of a nose of a face of a person wearing the face mask 100 to a bottom of a lower lip of the face and fully exposes a front facing elevation of eyes, nose and lips of the face. In other embodiments, the face shield 110 spans to a top of a forehead of the face, and to a bottom of a chin of the face.

The face shield 110 has three round openings bored in for attachment of air filters 201,202,203. The three openings substantially facing towards the ground being placed to sit perpendicular to the nose and the lip of the face. As a result, a side profile for the air filters reduces blockage relative to a front profile typical of air filters, particularly in areas around the nose and the chin. Blockage to the nostrils is also minimized by the air filter positioning. In one embodiment, the air filter are COVID-19 air filters, K-95 air filters, T70 air filters, or T90 air filters. There can also be one large opening, and additionally, there can be more than two openings, each configured to face towards the ground, in other embodiments. In another embodiment, the air filters are changeable, for instance when changing from an air filter to an air vent during exercise. The air filter can also be changed to a higher grade for more safety.

The support frame 120 secures the face shield 110 in place and at angles that prevents blockage to the face during a facial scan. The support frame 120 has limited obstructions to a front profile of the face. The support frame 120 is preferably rigid and itself can rest upon the face for stability. A nose bridge 130 attached to (or part of) the support fame 120 and spans from a first side of the nose over a top and to a second side of the nose. The nose bridge 130 also attaches to show a side profile to fully expose a front facing portion of the nose of the face.

A face cushion 140 attaches to the support frame 120 to seal the face mask 100 to the face. The face cushion 140 can be composed of a material that is more comfortable than the material of the support frame 120. For example, a soft rubber, cotton or some other material for human skin. The seal established between the face mask 100 and the face is sometimes critical to preventing the intake of contaminated air, acting as a respirator. Some embodiments do not seal and do not have a face cushion 140.

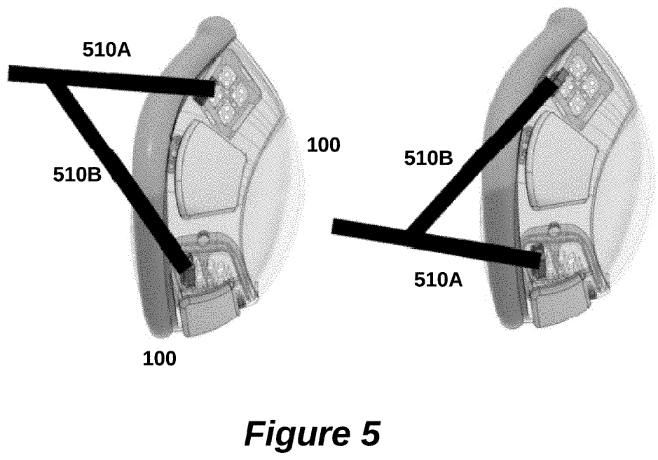

A strap 150 attached to the support frame to secure (and seal) the face mask 100 to the face. The material can be a breathable material for comfort. In one embodiment, the strap 150 is reversible, as shown in FIG. 5. In a first position, the straps support around a top of a head (i.e., 510A over 510B). In the second position, the straps support around a top of a neck (i.e., 510B over 510A). The strap 150 is reversed by disconnecting from the support frame 120 and rotating 180 degrees to be upside down, and then reattaching with the strap 150 being flipped. In one case, the strap 150 has one connection on each side of the head around ear height and near the face cushion 140. In another case, the strap has two connections on each side of the head, both above and below the ear. As a result, the strap 150 allows wearable attachments to the had when used for extended time for comfort, or reverse the strap 150 for wear under the ears so as not to interfere with hairstyle.

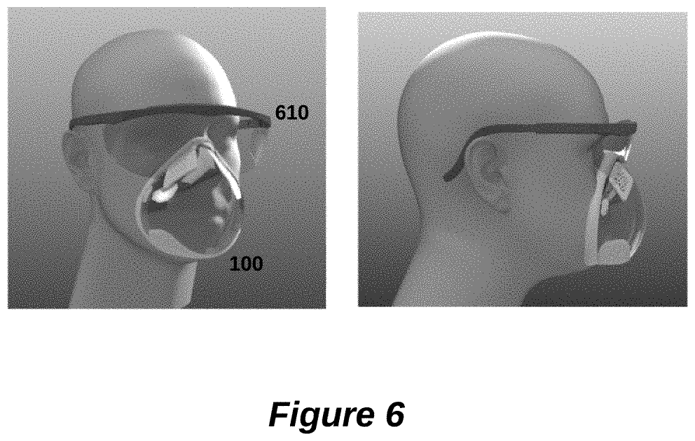

One embodiment uses a safety goggle frame 610, rather than straps for supporting the face mask 100, as shown in FIG. 6. In more detail, an upper portion of the face mask 100 can snap into a lower portion of the safety goggle frame 610. Arms of the safety goggle frame 610 are pressurized to provide the support when around the ears.

Advantageously, a face mask that accommodates rather than obstructs facial recognition.

II. Facial Recognition Computer Systems

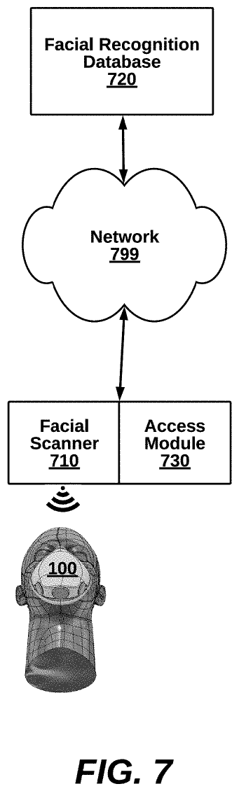

FIG. 7 is a high-level block diagram illustrating a system 700 for computerized facial recognition using the face mask 100, according to one embodiment. The system 700 includes the face mask 100 a facial scanner 710, a facial recognition database 720 and an access module 730. Components of the system 700 are implemented with computer hardware, software or a combination of both. Many other variations of the system 700 are possible.

The facial scanner 710 uses points on a face, as shown in FIG. 1, to optically capture as an image. The points can be searched against other captured images in the facial recognition database 720. If the present data points are within a sufficient distance to a record on the database, then a match is confirmed. The scanner can be a high-resolution camera from a smartphone, Internet camera, or other device with an appropriate lens to scan human faces including iris and eyes, nose, lips, and chin. The images can be digitally stored as jpg, gif, png, pdf or the like. Some implementations store data points that sample areas of an image but do not store the entire image itself in a reproducible format.

The access module 730 determines whether access will be granted to a person wearing the face mask 100 based on the facial scan. Different environments can require different levels of certainty for access. For example, facial recognition for access to an online bank account may have higher scrutiny than facial recognition for a video game account. In operation, the access module 730 can determine a statistical probability that the present scan matches a database record, and if a value of the statistical probability is within a predetermined range, access is granted. Otherwise, access may be denied.

The computing devices can include a memory, a processor, a storage drive, and an I/O port. Each of the components is coupled for electronic communication via a bus. Communication can be digital and/or analog, and use any suitable protocol. The memory further comprises applications and an operating system that execute on the processor as source code.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

We claim:

1. A clear-faced, virus protection face mask that exposes critical areas of a face needed for facial recognition, the face mask comprising:
a face shield with a support frame, the face shield being composed of a clear material to allow facial recognition, wherein the face shield spans from at least a top of a nose of a face of a person wearing the face mask to a bottom of a lower lip of the face and fully exposes a front facing elevation of eyes, nose and lips of the face, and
wherein the face shield has two or more openings for attachment of air filters, the two or more openings substantially facing towards the ground being substantially perpendicular to the nose and the lip of the face;
a nose bridge attached to the support fame and having a span from a first side of the nose over a top and to a second side of the nose, wherein the nose bridge and connected portions of the support frame minimize with side profiles that allow full exposure a front facing portion of the nose of the face;
a face cushion attached to the support frame to seal the face mask to the face; and
a strap attached to the support frame to secure the face mask to the face.

2. The face mask of claim 1, wherein the strap is reversibly attachable for mounting to the support frame, a first mounting position fit to an upper head and a second mounting position fit to a neck.

3. The face mask of claim 1, wherein the two or more openings each includes an air filter for trapping viruses.

4. The face mask of claim 1, wherein the two or more openings each includes an air filter for trapping COVID-19 viruses.

5. The face mask of claim 1, wherein the two or more openings each includes at least one of a K-95, a T70 or a T90 type air filter.

6. The face mask of claim 1, wherein the face shield is molded in a single process.

7. The face mask of claim 1, wherein the face shield spans from at least a top of a nose of a face of a person wearing the face mask to a bottom of a lower chin of the face and fully exposes a front facing elevation of eyes, nose and lips of the face.
